(19) United States
(12) Patent Application Publication
(10) Pub. No.: US 2007/0295212 A1
(43) Pub. Date: Dec. 27, 2007

(54) Filter Medium For Filtration Of Gases Filtration Device And Method For Production Of Filter Medium

(76) Inventors: Manuel Silva, Gouvix (FR); Maryse Jacquette, Flers (FR); Robert Klossek, Falaise (FR)

Correspondence Address: Berenato White&Stavish, 6550 Rock Spring Drive Suite 240, Bethesda, MD, 20817, US

(21) Appl. No.: 11/661,929

(22) PCT Filed: Sep. 8, 2005
(86) PCT No.: PCT/FR05/50722

§ 371 Date: Mar. 6, 2007

(30) Foreign Application Priority Data
Sep. 29, 2004 (FR) 0452193

(51) Int. Cl. B01D 39/00; B01D 39/16; B01D 46/00

(52) U.S. Cl. 95/285; 19/105; 19/98; 55/385.3

(57) ABSTRACT

The invention relates to a filter medium for the filtration of gases such as air for ventilation and/or heating and/or air conditioning of buildings or motor vehicles, comprising at least one web of fibres made up of a mixture of at least two fibre populations with different average diameter, each fibre population having in particular a yarn number of less than or equal to 50 decitex (dtex), preferable more than one equal to 1 decitex. The invention further relates to am method for production of said filter medium.

An object of the present invention is a filtering medium intended for the filtration of gases such as air for ventilation and/or heating and/or air conditioning of premises or motor vehicles, and a filtration device comprising the said medium.

Another object of the invention is a filtration method using the said device, and a method of fabricating the filtering medium.

A filtering medium of the prior art consists of intermingled fibres with a substantially constant diameter.

It can also be obtained by carding fibres as described in the patent FR 2 761 901, or by spinning a thermoplastic polymer through nozzles.

According to the application, a person skilled in the art chooses the mean diameter of the fibres that he wishes to use for fabricating a filtering medium.

The mean diameter of a batch of fibres is usually characterised by its yarn number (expressed in decitex).

In general terms, the more it is wished to obtain high efficacy of filtration, the “finer” will be the fibres chosen, in particular those whose number is less than 5 decitex. The result is in general a low clogging capacity.

Conversely, when it is wished to obtain filtering media with a high clogging capacity, “coarse” fibres will be chosen, in particular those whose number is above 5 decitex. The result however is low filtration efficacy.

The problem with these solutions relates to the difficulty in obtaining filtering media having at the same time high filtration efficacy and good clogging capacity.

The aim of the present invention is to remedy the following drawbacks. Consequently the aim of the invention is to produce a filtering medium with high efficacy and good clogging capacity.

This aim is achieved by virtue of a filtering medium intended for filtering gases such as air for ventilating, and/or heating and/or air conditioning premises or motor vehicles comprising at least one web of fibres where at least one web of fibres consists of a mixture of at least two populations of fibres with different mean diameters.

The inventors have found that, surprisingly, a filtering medium according to the invention makes it possible to obtain simultaneously high efficacy and good clogging capacity.

According to other characteristics of the filtering medium according to the invention:
each fibre population has a yarn number less than or equal to 50 decitex (dtex), preferably greater than or equal to 1 decitex;
the yarn number of two fibre populations of average diameter differs by a factor greater than or equal to 1.5, preferably greater than or equal to 1.6, or even greater than or equal to 2;
the mixture of at least two fibre populations with different mean diameters consists of 10 to 90% fibres with a smaller mean diameter, preferably 25 to 75% fibres with a smaller mean diameter, in particular substantially 50% fibres with a smaller mean diameter;
the fibres in the web of fibres are preferably chosen from the group of thermoplastic fibres such as polypropylene, polyethylene, polyester, polycarbonate or polyamide fibres, the group of acrylic fibres or preoxydised acrylic fibres; it is also possible to choose the fibres in the web of fibres from the group of aramid fibres, from the group of phenolic fibres, from the group of fluorocarbon fibres, from the group of mineral fibres such as glass fibres, or from the group of metal fibres;
the fibres in the web of fibres are long fibres and are mixed by a carding operation in order to form a card web;
the fibres in the web of fibres have a mean length greater than or equal to 38 mm and preferably less than or equal to 120 mm;
the filtering medium comprises a second web of fibres disposed parallel to the web of fibres consisting of a mixture of at least two populations of fibres with different mean diameters, and active particles, in particular carbon, disposed between the two webs of fibres;
the yarn number of the fibres in the second web is less than or equal to the smallest yarn number of the web fibres in the mixture of fibres.

The invention also relates to a filtration device, more particularly intended for filtering a gas such as air and intended for ventilating and/or heating and/or air conditioning premises or motor vehicles, that comprises the above filtering medium.

The filtration device comprises a frame, in general consisting of strips of flexible or rigid polymer, to which the filtering medium is fixed. A normal filtration device usually comprises two or four parallel strips in pairs. The filtering medium is generally folded in a concertina before being fixed to the strips of polymer.

The invention also concerns a method of filtering gases such as air where there is disposed, in an air stream, a filtration device according to the invention, comprising a web of fibres of at least two populations with different mean diameters and a second web of fibres and active particles between the two webs, so that the incoming air flow passes first of all through the web of fibres consisting of at least two populations of fibres with different mean diameters.

The invention also concerns a method of fabricating a filtering medium intended for the filtration of gases such as air comprising at least the following successive steps:
fibres consisting of at least two populations of fibres with different mean diameters and whose yarn number is less than or equal to 50 decitex, and preferably greater than or equal to 1 decitex, are supplied,
the fibres supplied are mixed,
the mixture is introduced into a carding device,
a carding operation is carried out in order to form a card web.

According to one embodiment, the method uses fibres where the yarn number of two populations with a mean diameter differs by a factor greater than or equal to 1.5, preferably greater than or equal to 1.6, or even greater than or equal to 2.

According to one advantageous characteristic, the method comprises a subsequent step of hydraulic binding of the fibres, in particular by water jet, in order to increase the mechanical consolidation of the card web.

It may also be advantageous to add a grille during the carding operation.

According to another characteristic the method comprises a subsequent step of shaping, in particular calendering or lamination, during which the said card web and a second web are introduced into a forming device for joining the two webs, and where active particles, in particular carbon, are inserted between the two webs, in particular during a calendering or lamination operation.

Other details and advantageous characteristics will emerge from the following description of non-limiting preferred embodiments.

Three combined filters were fabricated with filtering media, comprising a top web of fibres, a bottom web of fibres and active carbon between the two webs of fibres, according to the prior art (Ex 1 and Ex 2) and according to the invention (Ex 3) with the following characteristics:

Top web

| | Fibres | Fibres | Activated | Bottom |
|---|---|---|---|---|
| | 2.8 dtex | 5.5 dtex | carbon | web |
| Ex 1 | 100% | 0% | 300 g/m² | 2.8 dtex |
| Ex 2 | 0% | 100% | 300 g/m² | 2.8 dtex |
| Ex 3 | 50% | 50% | 300 g/m² | 2.8 dtex |

The fibres used were carded according to the teaching of the patent FR 2 761 901.

The weight per surface area of the top webs is 38 g/m².

The web per surface area of the bottom webs is 40 g/m².

Examples 1 and 2 use a filtering medium with a single population of fibres, unlike example 3, according to the invention, where two populations of fibres were mixed.

The activated carbon is held between the two webs by an adhesive.

After folding in identical ways, the three filtering media were fixed to two foam strips of 5 mm made from polypropylene so as to obtain filtration devices with a width of 206 mm, a length of 208.5 mm and a height of 30 mm.

The filtration devices were characterised as defined by the ISO standard TS 11155-1.

The top web is placed at the air flow entry. The dust used is of the SAE fine type, referred to as ISOFINE (A2 fine test dust—ISO 12103-1).

The following table summarises the results obtained:

| Filtration device with | Pressure drop at | Mean clogging capacity |
|---|---|---|
| filtering medium | 420 m³/h (Pa) | at 180 m³/h (g) |
| Ex 1 | 146 | 19.7 |
| Ex 2 | 142 | 55.6 |
| Ex 3 | 152 | 48.9 |

The measurements carried out on the three examples show that the pressure drop is not significantly influenced by the type of fibre of the filtering medium (the dispersion of the pressure drop measurements is estimated at approximately 10%).

It is observed in a known manner that the clogging capacity of a filtering medium of “coarse” fibres (Ex 2) is very much greater than that of a medium of “fine” fibres (Ex 1).

Surprisingly the clogging capacity of a filtering medium consisting of a mixture of “coarse” and “fine” fibres (Ex 3) is close to that of a filtering medium of “coarse” fibres (Ex 2).

In order to characterise a filter the variation in the mean efficacy (in “%”) is also measured as a function of the particulate spectrum (in micrometres), at different phases of the life of the filter.

The pressure Po is determined at the outlet of a new filter in which an air flow of 180 m³/h is caused to pass containing 75 mg/m³/h of Isofine dust and the variation in efficacy over time is recorded, at a constant flow of loaded air for characteristic pressures, in particular Po+125 Pa, Po+250 Pa.

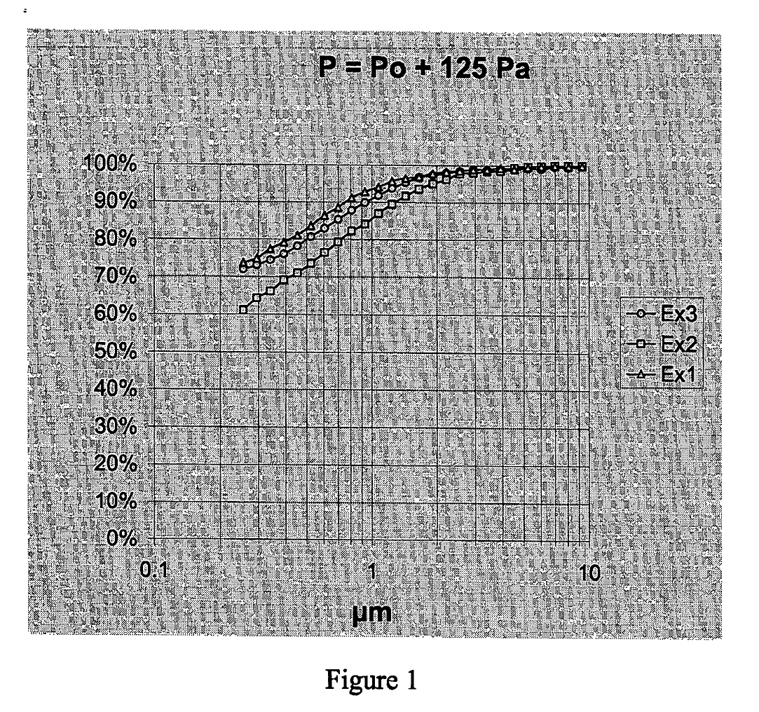

FIG. 1 presents the mean efficacy variation as a function of the particulate spectrum for the three examples Ex 1, Ex 2 and Ex 3 for a pressure Po+125 Pa.

It should be noted that, as is usual, the mean efficacy of a medium of “fine” fibres (Ex 1) is very much greater than that of a medium with “coarse” fibres (Ex 2).

Surprisingly it is seen that the filtering medium according to the invention, consisting of a mixture of “coarse” and “fine” fibres (Ex 3), has a mean efficacy close to that of a medium of “fine” fibres (Ex 1).

This behaviour is observed during the various phases of the life of a filter with a filtering medium consisting of a mixture of fibres as demonstrated by the following table. The value of the efficacy for a particle size of 1 micrometre, representing the most copious dust to be filtered in a vehicle, is entered as a function of pressure.

| Filtration | Mean efficacy at 1 μm | | |
|---|---|---|---|
| device | P = Po | P = Po + 125 Pa | P = Po + 250 Pa |
| Ex 1 | 65% | 93% | 95% |
| Ex 2 | 50% | 85% | 88% |
| Ex 2 | 58% | 91% | 95% |

In this way there is obtained according to the invention a remarkable filtering medium that makes it possible to obtain filtration devices whose mean efficacy is high, whilst also having a high clogging capacity.

The invention is not limited to these types of embodiment and must be interpreted non-limitingly, encompassing any filtering medium and filtration device where at least one web of fibres consists of a mixture of at least two populations of fibres with different mean diameters.

1. Filtering medium intended for filtering gases for ventilating and/or heating and/or air conditioning premises or motor vehicles, comprising at least one web of fibres, wherein at least one web of fibres consists of a mixture of at least two populations of fibres with different mean diameters.

2. Filtering medium according to claim 1, characterised in that each fibre population has a yarn number less than or equal to 50 decitex (dtex), preferably greater than or equal to 1 decitex.

3. Filtering medium according to claim 1, characterised in that the yarn number of two fibre populations of average diameter differs by a factor greater than or equal to 1.5, preferably greater than or equal to 1.6, or even greater than or equal to 2.

4. Filtering medium according to claim 1, characterised in that the mixture of at least two populations of fibres with different mean diameters consists of 10 to 90% fibres with a smaller mean diameter, preferably 25 to 75% fibres with a smaller mean diameter, in particular substantially 50% fibres with a smaller mean diameter.

5. Filtering medium according to claim 1, characterised in that the fibres in the said web of fibres are preferably chosen from the group of thermoplastic fibres such as polypropylene, polyethylene, polyester, polycarbonate or polyamide fibres, the group of acrylic fibres or preoxydised acrylic fibres, from the group of aramid fibres, from the group of phenolic fibres, from the group of fluorocarbon fibres, from the group of mineral fibres such as glass fibres, or from the group of metal fibres.

6. Filtering medium according to claim 1, characterised in that the fibres in the at least one web of fibres are long fibres and are mixed by a carding operation in order to form a card web.

7. Filtering medium according to claim 6, characterised in that the fibres in the web of fibres have a mean length greater than or equal to 38 mm and less than or equal to 120 mm.

8. Filtering medium according to claim 1, further comprising a second web of fibres disposed parallel to the web of fibres consisting of a mixture of at least two populations of fibres with different mean diameters, and active particles, in particular carbon, disposed between the two webs of fibres.

9. Filtering medium according to claim 8, characterised in that the yarn number of the fibres in the second web is less than or equal to the smallest yarn number of the web fibres in the mixture of fibres.

10. Filtration device particularly intended for filtering gases such as air and intended for ventilating and/or heating and/or air conditioning premises or motor vehicles, wherein said device comprises a filtering medium according to claim 1.

11. Method of filtering gases, comprising the steps of:
introducing a filtration device intended for filtering gases and for one of ventilating, heating and air conditioning an area into an air stream, wherein said filteration device comprises a filtering medium including a first web of fibres consisting of a mixture of at least two populations of fibres with different mean diameters: a second web of fibres disposed parallel to the first web of fibres consisting of a mixture of at least two populations of fibres with different mean diameters, and active carbon particles disposed between the first and second webs of fibres and
disposing the web of fibres consisting of a mixture of at least two populations of fibres with different mean diameters of the said filtration device at the entry of the airflow.

12. Method of fabricating a filtering medium intended for the filtration of gases such as air comprising at least the following successive steps:
fibres consisting of at least two populations of fibres with different mean diameters and whose yarn number is less than or equal to 50 decitex, and preferably greater than or equal to 1 decitex, are supplied,
the fibres supplied are mixed,
the mixture is introduced into a carding device,
a carding operation is carried out in order to form a card web.

13. Method according to claim 12, characterised in that the yarn number of the two populations with different mean diameters differs by a factor greater than or equal to 1.5, preferably greater than or equal to 1.6, or even greater than or equal to 2.

14. Method according to claim 12, characterised in that said method comprises a subsequent step of hydraulic binding of the fibres, by water jet, in order to increase the mechanical consolidation of the card web.

15. Method according to claim 12, characterised in that a grille is added during the carding operation.

16. Method according to claim 12, wherein said method comprises a subsequent step of shaping, during which the said card web and a second web are introduced into a forming device for joining the two webs, and where active particles, in particular carbon, are inserted between the two webs, during a calendering or lamination operation.
